(19) United States
(12) Patent Application Publication
(10) Pub. No.: US 2007/0277380 A1
(43) Pub. Date: Dec. 6, 2007

(54) Hand held powered citrus juicer

(76) Inventors: Philip Maher, Los Angeles, CA (US); Maher Salama, Los Angeles, CA (US); Amgad Salama, Los Angeles, CA (US)

Correspondence Address: JAMES RAY & ASSOCIATES, 2640 PITCAIRN ROAD, MONROEVILLE, PA, 15146, US

(21) Appl. No.: 11/801,838

(22) Filed: May 11, 2007

Related U.S. Application Data
(60) Provisional application No. 60/800,745, filed on May 16, 2006.
(60) Provisional application No. 60/800,748, filed on May 16, 2006.

(51) Int. Cl. A23N 5/00

(52) U.S. Cl. 30/120.1

(57) ABSTRACT

A citrus juicer includes an element for extracting juice from a citrus half and an elongated hollow housing which is axially aligned with the juice extracting element. A rotary drive mechanism is mounted within the housing and includes a motor and a drive shaft operably connected to the juice extracting element. A power source is disposed within the hollow housing and is capable of supplying the predetermined voltage to the motor for rotating the element. A switch is provided for selectively activating and terminating the supply of the predetermined voltage from the power source to the motor. The citrus juicer may be further adapted with a bowl and a cover arrangement for covering the juice extracting element and wherein the drive mechanism will be capable of axially and linearly moving the juice extracting element to penetrate the citrus half.

### CROSS-REFERENCE TO RELATED APPLICATIONS

This application is related to and claims priority from Provisional Patent Application Ser. No. 60/800,745 and Provisional Patent Application Ser. No. 60/800,748 both filed May 16, 2006.

### FIELD OF THE INVENTION

The present invention relates, in general, to citrus juicers having a rotating cone and, more particularly, this invention relates to a hand held battery operated citrus juicer having a rotating cone and, yet more particularly, the instant invention relates to a hand held battery operated citrus juicer having a rotating cone which eliminates the need for the user to manually push the citrus half against the rotating cone.

### BACKGROUND OF THE INVENTION

As is generally well known, while many enjoy the taste of freshly squeezed juice, few individuals take the time to freshly squeeze their own fruit juices from lemon, lime, or orange, as this is often a messy and time-consuming process. With a conventional hand held juicer implement, to obtain fresh juice, an individual must apply sufficient manual force coupled with a twisting motion. With a lever operated citrus squeezing devices, the amount of force needed and the orientation in which the fruit must be applied depends on the device used to squeeze the citrus. Power operated citrus juicers, which are well known in the art, while reducing the need for manual effort, require greater than desirable clean-up effort. Furthermore, size of such prior art power citrus juicers and presence of the electrical cord hinders their use in some situations requiring freshly squeezed citrus juices.

### SUMMARY OF THE INVENTION

According to one aspect, the invention provides a citrus juicer. The citrus juicer includes an element for extracting juice from a citrus half. An elongated hollow housing is axially aligned with the juice extracting element. The housing has a top end thereof positioned in close proximity to a base of the juice extracting element. A rotary drive means is operably mounted within the housing. The rotary drive means includes a motor and a drive shaft operably connected to the juice extracting element. A power source is disposed within the hollow housing and is capable of supplying the predetermined voltage to the rotary drive means. The supply of the predetermined voltage enables the rotary drive means to rotate the juice extracting element. A control means is provided for selectively activating and terminating the supply of the predetermined voltage from the power source to the rotary drive means.

According to another aspect, the invention provides a citrus juicer. The citrus juicer includes an element for extracting juice from a citrus half. An elongated hollow housing is axially aligned with the juice extracting element. The housing has a top end thereof positioned in close proximity to a base of the juice extracting element. A drive means is operably mounted within the hollow housing for rotating the juice extracting element and for axially and linearly extending and retracting the juice extracting element relative to the top end of the hollow housing. A power source is disposed within the hollow housing and is capable of supplying the predetermined voltage to the drive means. The supply of the predetermined voltage enables the drive means to axially and linearly move the juice extracting element to selectively penetrate and release the citrus half and rotate the juice extracting element for extracting the juice. A control means is provided for selectively activating and terminating the supply of the predetermined voltage from the power source to the drive means. There is means for forming an enclosed and hollow working space for the juice extracting element. The working space means includes a bowl portion which is secured to and extends outwardly and axially from the top end of the housing for at least partially covering the juice extracting element and a cover portion which is engageable with a mouth of the bowl portion for completely covering the juice extracting element. A hinge means is provided for hingeably attaching the cover portion to the bowl portion enabling the cover portion to be pivotally moved between a first position for covering the juice extracting element and a second position for uncovering the juice extracting element. A securing means is provided for securely attaching the cover portion being disposed in the first position to the bowl portion. A spout is disposed on and secured to one of the bowl portion and the cover portion for communicating flow of the extracted juice external to the citrus juicer when the cover portion is disposed in the first position.

### OBJECTS OF THE INVENTION

It is, therefore, one of the primary objects of the present invention to provide a hand held battery operated citrus juicer having a rotating cone.

Another object of the present invention is to provide a hand held battery operated citrus juicer which is convenient to transport to a point of use.

Yet another object of the present invention is to provide a hand held battery operated citrus juicer which significantly reduces clean-up effort of extracting juice from a citrus half.

A further object of the present invention is to provide a hand held battery operated citrus juicer which eliminates juice splatter.

Yet a further object of the present invention is to provide a hand held battery operated citrus juicer which is simple to use.

An additional object of the present invention is to provide a hand held battery operated citrus juicer which is capable of releaseably securing citrus half prior to juice extraction therefrom.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is an elevation view of a hand held powered citrus juicer constructed according to one embodiment of the invention;

FIG. 2 is a cross-sectional view of the hand held powered citrus juicer along lines 2-2 of FIG. 1;

FIG. 3 is a perspective view illustrating use of the hand held powered citrus juicer of FIG. 1 for extracting juice from citrus half and also illustrating the battery charging device which is constructed according to one embodiment of the invention;

FIG. 4 is a cross-sectional elevation view illustrating a hand held powered citrus juicer constructed according to another embodiment of the invention, particularly illustrating a presently preferred drive mechanism;

FIG. 5 is a block diagram of the hand held powered citrus juicer of FIG. 4;

FIG. 6 is a perspective view of the hand held powered citrus juicer of FIG. 4, particularly illustrating loading of the citrus half for extracting juice therefrom;

FIG. 7 is a perspective view showing use of the hand held powered citrus juicer of FIG. 4 for extracting juice from citrus half; and

FIG. 8 is a partial schematic diagram of the hand held powered citrus juicer of FIG. 4, particularly illustrating a drive mechanism constructed according to an alternative embodiment of the invention and also illustrating a battery charging device which is constructed according to another embodiment of the invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

Reference is now made, to FIGS. 1-4, wherein there is shown a citrus juicer, generally designated as 10, and which is constructed according to one embodiment of the invention. The citrus juicer 10 includes an element 20 for extracting juice from a citrus half 2, such as lemon, lime, orange and the like. Such element 20 may be any one of elements presently employed in powered juicers and which are generally known as rotating cones. Preferably, such juice extracting element has an egg-shaped outer surface 22 which converges to a generally sharp top end 24. A plurality of spaced vertical grooves 26 are formed within the outer surface 22 and converge adjacent the top end 24. The outer surface 22 also has a plurality of spaced annular ridges 28 formed thereon.

The citrus juicer 10 further includes an elongated hollow housing 30 which is axially aligned with the juice extracting element 20 and which has a top end 32 thereof positioned in close proximity to a base 21 of the juice extracting element 20. An exterior surface 34 of the housing 30 has a predetermined shape enabling the housing 30 to be ergonomically received within and held by the right or left hand 4 of the user of the citrus juicer 10. By way of example of FIG. 1, the housing 30 may be provided with a bulbous portion 36 which is formed on the exterior surface 34 intermediate the ends of the housing 30. The housing 30 may be also adapted with anti-slip grip means disposed on and secured to the exterior surface 34 of the hollow housing 30. For example, such anti-slip grip means may include a plurality of spaced projections 38 and recesses 39. Furthermore, the anti-slip grip means may include an anti-slip material which is selected from any well known polymers presently used on hand tools, kitchen utensils, bicycle handle bars and the like. The present invention contemplates that the housing 30 may be formed entirely from such material. It is presently preferred to provide a watertight fit between the juice extracting element 20 and the top end 32 of the housing 30 for cleaning purposes. The watertight fit can be achieved by any presently employed methods for attaching operating elements in the hand held kitchen appliances in an arrangement which enables cleaning thereof under a stream of water.

There is a rotary drive means, generally designated as 40, which is mounted within the housing 30 for rotating the juice extracting element 20. The rotary drive means 40 includes a motor 42 and a drive shaft 44 which is operably connected at one end thereof to the juice extracting element 20 and which is connected at a distal end thereof to the motor 42 either directly or through the gearing arrangement 46 or belt arrangement (not shown). In a conventional manner, the motor 42 is an electric motor which is operable by supply of a predetermined voltage from the power source to rotate the drive shaft 44 and rotate the juice extracting element 20 being secured to such drive shaft 44. In a conventional manner, the citrus juicer 10 may include a power cord 12 for connection to a conventional power outlet (not shown).

However, it is presently preferred for the power source to be operably disposed within the hollow housing 30 and being capable of supplying the predetermined voltage to the motor 42. Accordingly, the citrus juicer 10 includes at least one battery 50 which may be one of a rechargeable and a disposable type. When the citrus juicer 10 includes at least one rechargeable battery 50, it further includes means for recharging the at least one rechargeable battery 50. Such recharging means may simply include a contact 52 and a connection means such as a female connector 54 which is accessible from the exterior surface 34 of the housing 30 for connection to a male connector 58 of a charging device 56 which is capable of converting AC or DC voltage and which is shown in FIG. 3 as adapted for converting AC voltage from a conventional power outlet (not shown).

The citrus juicer 10 additionally includes a control means for selectively activating and terminating the supply of the predetermined voltage from the power source 50 to the rotary drive means 40. It is presently preferred for such control means to include a switch means 72 electrically connected intermediate the rotary drive means 40 and the power source 50 for supplying and terminating the predetermined voltage. Preferably, the switch means 72 is positioned within a side wall of the hollow housing 30 and is manually operable by the user. Alternatively, the switch means may be mounted within the housing 30 and operable when the user presses down on the juice extracting element 20. Such operation is taught for example in U.S. Pat. No. 6,860,196 issued to Areh et al. which is incorporated into this document by reference thereto.

In operation, as best shown in FIG. 3, the user simply holds the citrus juicer 10 with one hand while holding the citrus half 2 with the other hand, over a bowl or cup. With minimal hand force, the user advances the citrus juicer 10 toward the citrus half 2 to insert the top end 24 of the juice extracting element 20 thereinto. When the user actuates the switch means 72, the power is supplied to the drive means 40 enabling the motor 42 to rotate or spin the juice extracting element 20 and extract the juice from the citrus half 2. The spinning action of the juice extracting element 20 can be accomplished according to various techniques. Preferably, the control means is arranged to continue spinning the juice extracting element 20 in one direction while the user continues to actuate the switch means 72 and will terminate spinning action when the user deactuates the switch means 72. A subsequent actuation of the switch means 72 will enable spinning action of the juice extracting element 20 in the opposite direction. With this spinning technique, the user is assured to extract the most juice from the fruit half 2.

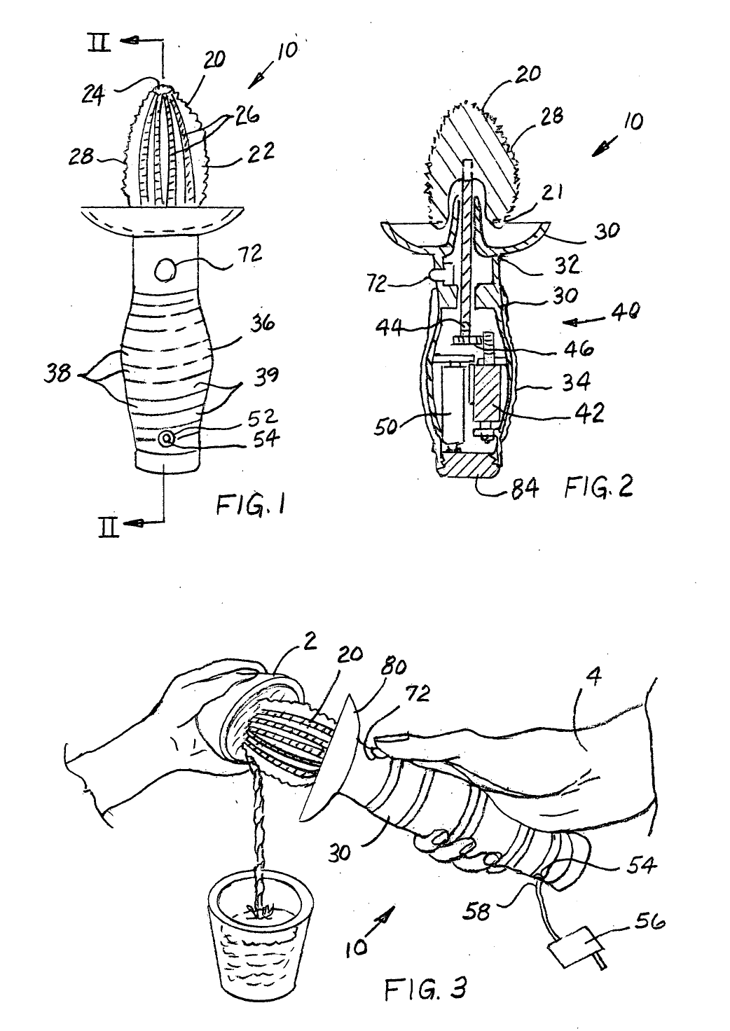

The present invention contemplates for the citrus juicer 10 to include a guard member 80 which is stationary attached to the top end 32 of the housing 30 in proximity to the base 21 of the juice extracting element 20. It will be appreciated that the guard 80 may be integrally formed with the housing 30. Preferably, guard 80 is formed as a concave annular member which is oriented toward the top 24 of the juice extracting element 20 and which is capable of containing at least a portion of the juice extracted from the citrus half 2 should the user neglect to tilt the juice extracting element 20 during use. Furthermore, the housing 30 may be provided with a cover 84 for selectively allowing access to the at least one battery 50. By way of example only in FIG. 2, such cover portion 84 may be threadably attached to a bottom end of the housing 30.

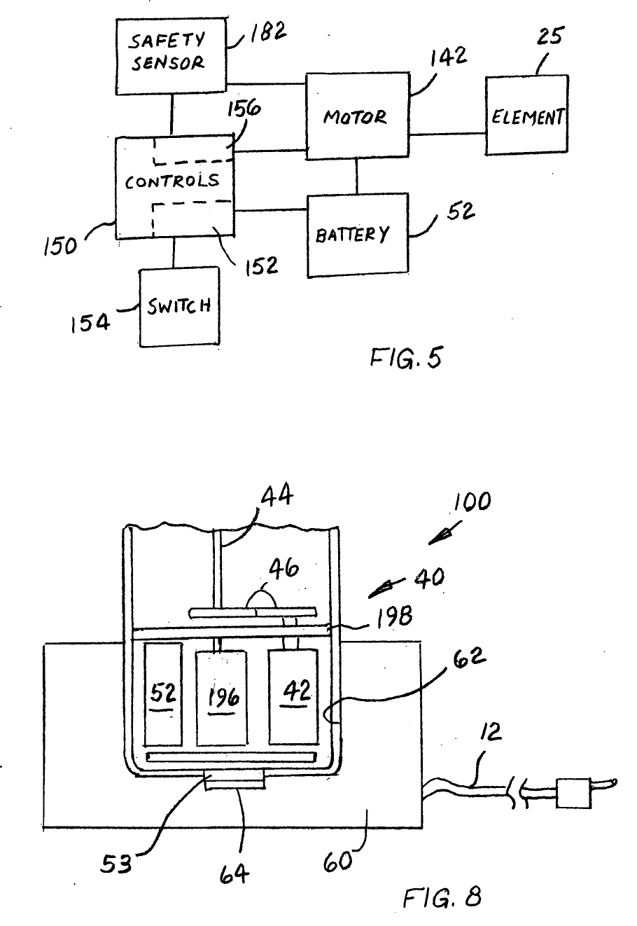

According to another embodiment, the invention provides a citrus juicer, generally designated as 100. Now in reference to FIGS. 5-8, the citrus juicer 100 includes an element 20 for extracting juice from a citrus half 2. Such element 20 may be any one of elements presently employed in powered juicers and which are generally known as rotating cones. Preferably, such juice extracting element has an egg-shaped outer surface 22 which converges to a generally sharp top end 24. A plurality of spaced vertical grooves 26 are formed within the outer surface 22 and converge adjacent the top end 24. The outer surface 22 also has a plurality of spaced annular ridges 28 formed thereon.

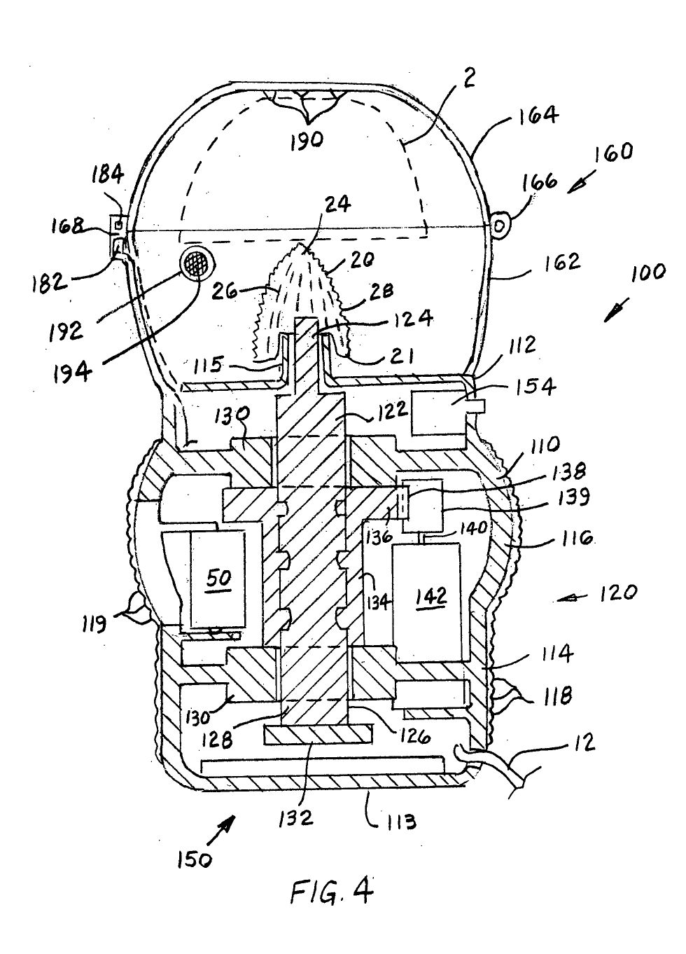

The citrus juicer 100 further includes an elongated hollow housing 110 which is axially aligned with the juice extracting element 20 and which has a top end 112 thereof positioned in close proximity to a base 21 of the juice extracting element 20. An exterior surface 114 of the housing 30 has a predetermined shape enabling the housing 110 to be ergonomically received within and held by the hand of the user of the citrus juicer 10. By way of example of FIG. 4, the housing 110 may be provided with a bulbous annular portion 116 which is formed on the exterior surface 112 intermediate the ends of the housing 110. The housing 110 may be also adapted with anti-slip grip means disposed on and secured to the exterior surface 114 of the hollow housing 110. For example, such anti-slip grip means may include a plurality of spaced projections 118 and recesses 119. Furthermore, the anti-slip grip means may include an anti-slip material which is selected from any well known polymers presently used on hand tools, kitchen utensils, bicycle handle bars and the like. The present invention also contemplates that the housing 110 may be formed from such material in its entirety. It is presently preferred to provide a watertight fit between the juice extracting element 20 and the top end 112 of the housing 110 for cleaning purposes. The watertight fit can be achieved by any presently employed methods for attaching operating elements in the hand held kitchen appliances in an arrangement which enables cleaning thereof under a stream of water.

For reasons to be described later, the citrus juicer 100 includes a drive means, generally designated as 120, which is operably mounted within the housing 110 for rotating the juice extracting element 20 and for axially and linearly extending and retracting the juice extracting element 20 relative to the top end 112 of the housing 110. Now in a particular reference to FIG. 4, the drive means 120 of one embodiment includes a drive shaft 122 which is operably connected at a first end 124 thereof to the juice extracting element 20. The second end 126 of the drive shaft 122 is formed with a helical thread portion 128. At least one and preferably a pair of top and bottom support members 130 which are stationary mounted within the housing 110 are provided for supporting the drive shaft 122 for rotary and linear movements. A stop member 132 is disposed on and secured to the second end 126 of the drive shaft 122 and abuts a bottom support member 130 for limiting the axial extension of the first end 124 above the top end 112 of the housing 110. A drive nut 134 is operably coupled to the helical thread portion 128 and is restricted against axial movement by the pair of support members 130. The drive nut 134 is fitted with an annular ring 136 which has a spur gear means 138 being disposed and secured to exterior surface thereof. Preferably, the spur gear means 138 is formed integral to the annular ring 136. The spur gear means 138 is operatively coupled to a complimentary worm gear means 139 which is disposed on and secured to the output shaft 140 of the electrically operated motor 142. In a conventional manner, the motor 142 is an electric motor which is operable by supply of a predetermined voltage from the power source to rotate the juice extracting element 20. In a conventional manner, the citrus juicer 110 may include a power cord 12 for connection to a conventional power outlet (not shown).

However, it is presently preferred for the power source to be operably disposed within the hollow housing 110 and being capable of supplying the predetermined voltage to the rotary drive means 120. Accordingly, the citrus juicer 100 includes at least one battery 50 which may be one of a rechargeable or a disposable type. When the citrus juicer 10 includes at least one rechargeable battery 50, it further includes means for recharging the at least one rechargeable battery 50. Such recharging means may simply include an electrical contact 52 and a connection means such as a female connector 54 which is accessible from the exterior surface 112 of the housing 110 for connection to a male connector 58 of a charging device 56 which is capable of converting AC or DC voltage. Alternatively, as best shown in FIG. 8, the electrical contacts 53 may be mounted within a bottom end 113 of the housing 110 and a charging device 60 may be provided with a cavity 62 for receiving a portion of the housing 110 and which is equipped with complimentary contacts 64 for mating with contacts 52 of the citrus juicer 100. In a conventional manner, the charger 60 is provided with a power cord 12 for connection to a standard power wall outlet (not shown) or for connection to a cigarette light receptacle of a vehicle (not shown). It will be appreciated that the charger 60 may be adapted for charging the citrus juicer 10 in a similar manner.

The citrus juicer 100 additionally includes a control means, generally designated as 150, for selectively activating and terminating the supply of the predetermined voltage from the power source 50 to the drive means 120. Now in further reference to FIG. 5, it is presently preferred for such control means to include a logic means 152, for example such as a microprocessor, and a switch means 154 electrically connected to the logic means 152 and to the drive means 140 for supplying and terminating the predetermined voltage. Preferably, the switch means 154 is positioned within a side wall of the hollow housing 110 and is manually operable by the user.

The citrus juicer 100 includes means, generally designated as 160, engageable with the top end 112 of the housing 120 for a creating an enclosed and hollow working space for the juice extracting element 20. It is presently preferred for such working space means 160 to include a bowl portion 162 which is secured to and extends outwardly and axially from the top end 112 of the housing 110 and at least partially encloses the juice extracting element 20. A dome-shaped cover portion 164 is removably mounted over a mouth of the bowl portion 162 for completely covering the juice extracting element 20. Both the bowl portion 162 and the cover portion 164 are manufactured from a translucent or transparent plastic material for enabling the user to observe the juice extracting process. Preferably, the working space means 160 includes a hinge means 166 for hingeably mounting the cover portion 164 to the bowl portion 162 enabling the cover portion 164 to be pivotally moved between a first position for covering the juice extracting element 20 and a second position for uncovering the juice extracting element 20. A securing means, such as a latch means 168 is provided for securing the cover portion 164 being disposed in the first position to the bowl portion 162. Such latch means 168 may be of any type presently employed in kitchen appliances, particularly of a food processor type, for securing a cover or a lid to the bowl. However, the present invention also contemplates that the cover portion 164 may be securely attached the bowl portion 162 by a friction fit therebetween or by employment of complimentary locking tabs (not shown).

Advantageously, the citrus juicer 100 includes a safety interlock means for enabling operation of the drive means 110 only when the cover portion 164 is disposed in the first position and is secured to the bowl portion 162. Such safety interlock means may be of any type employed in a kitchen appliance of a food processor type. By way of an example only, such interlock means may include a magnetic sensor 182 secured to the bowl portion 162 which senses a magnetic target 184 mounted within the cover portion 164 and provides a signal to the control means upon sensing the magnetic target 184 when the cover portion 164 is moved into the first position. Such safety interlock means may be of the type as disclosed in U.S. Pat. No. 4,741,482 issued to Coggiola and which is incorporated into this document by reference thereto. It will be apparent to those skilled in the art that any other type of sensing devices can be employed in the present invention as well as that such safety interlock means can be simply incorporated into the latch means 168.

The cover portion 164 is adapted with a plurality of spikes 190 which are formed on an interior surface thereof and which are arranged in a predetermined pattern for releaseably securing a citrus half 2 during use. It is presently preferred for the spikes 190 to be formed in a circular pattern and it is further preferred to omit the spike in the center of such circular pattern in order to securely receive the citrus half 2 having a conically shaped end.

A spout 192 is disposed on and secured to one of the bowl portion 162 and the cover portion 164 for communicating flow of the extracted juice external to the citrus juicer 100 when the cover portion 164 is disposed in the first position. An optional filter means 194 may be operatively secured to the spout 192 for filtering flow of the extracted juice.

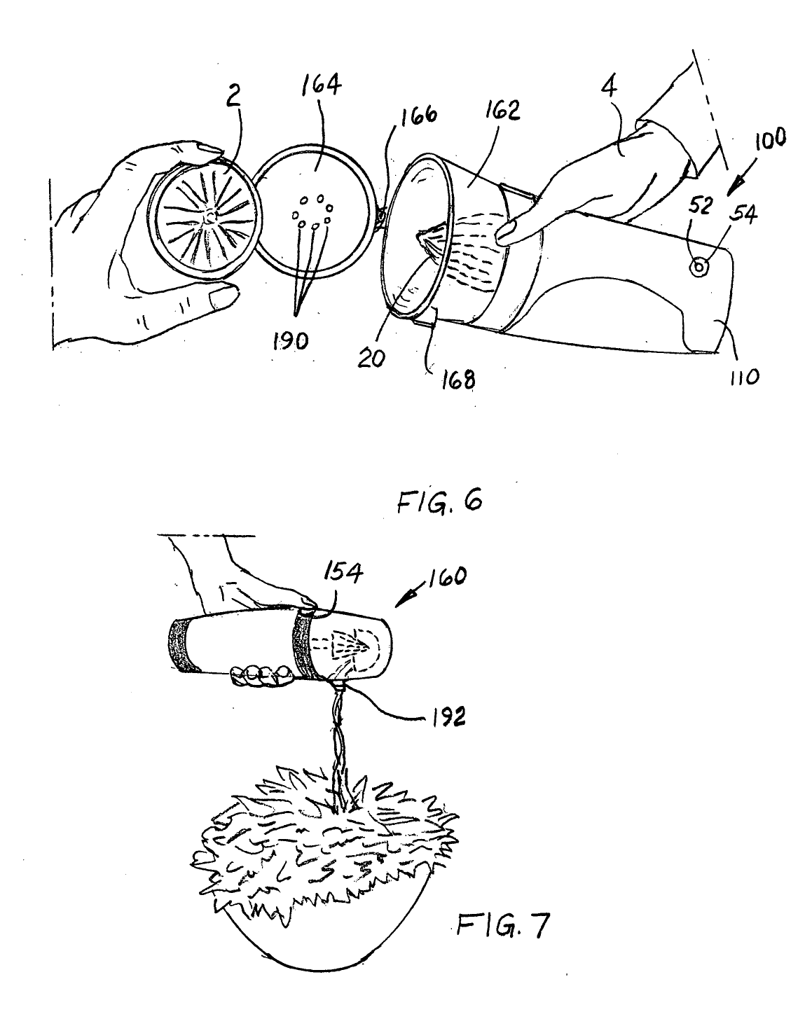

The use of the citrus juicer 100 is best illustrated in FIGS. 6-7. To extract juice from the citrus half 2, the user simply moves the dome-shaped and hinged cover portion 164 into the second position to expose the juice extracting element 20, and then positions the citrus half 2 snuggly onto the spikes 190 formed inside this cover portion 164. These spikes 190 will firmly hold the citrus half 2 in place during the juicing process. The user then moves the cover portion 164 into the second position and secures it by way of the latch means 168 enabling the cut surface of the citrus half 2 to be positioned in close proximity to the to end 24 of the juice extracting element 20. At the same time, the magnetic sensor 182 senses presence of the target 184 and provides safety interlock signal to the control means 150. Next, the user simply activates the switch means 162 enabling the drive means 120 to axially extend the juice extracting element 20 into the citrus half 2 and rotate or spin the drive shaft 124 and rotate or spin such juice extracting element 20 to extract juice. The spinning action may be of a reversing type as described above for the citrus juicer 10 and may be further arranged in accordance with a predetermined sequence depending on specific application requirements. The juice extracting element 20 will extend until the stop member 132 abuts the bottom support 130 resulting only in the rotational motion of the juice extracting element 20. If required, an overcurrent sensing means 156 will be provided within the control means 150 to terminate operation of the drive means 120. When the switch means 154 is deactivated, the juice extracting element 20 will retract toward the top end 112 of the housing 110 and rest on the outwardly extending annular flange portion 115. Or, the logic means 152 may be configured to enable the axial and rotary movements of the juice extracting element 20 according to the predetermined sequence once the user activates and releases the switch means 154.

The user may elect to hold the citrus juicer 100 horizontally or at an angle over the dish or bowl while activating the switch means 154 and enabling the extracted juice to discharge through the spout 192. Or the user may elect to stand the citrus juicer 100 in the upright position wherein the bottom end 113 of the housing 110 is sized to enable freestanding position of the citrus juicer 100. When juice is extracted form the citrus half 2, the user simply unlatches and opens the cover portion 164 and removed the citrus half 2 having juice extracted therefrom. The user may then insert a new citrus half 2 and repeat the juice extracting process or may clean the citrus juicer 100 and store it for future use. It will be appreciated that the citrus juicer 100 of the present invention eliminates the need for the user to apply manual force in order to extract juice and provides for a more automatic operation of extracting juice from the citrus half 2. Fully enclosing the juice extracting element 20 prevents juice splatter during use and enables the citrus juicer 100 to be used in dining establishments to introduce freshly squeezed citrus juice in a manner of introducing freshly ground pepper and where use of the prior art powered citrus juicer is unacceptable or impractical.

Although the present invention has been shown in terms of the juice extracting element 20 having an egg-shaped outer surface adapted with ridges and grooves, it will be apparent to those skilled in the art, that any other juice extracting elements presently in use can be employed in the citrus juicer 10 or citrus juicer 100 of the present invention.

Furthermore, as illustrated in FIG. 8, the citrus juicer 100 may employ a simple solenoid 196 for axially extending and retracting the juice extracting element 20. Accordingly, the citrus juicer 100 will be provided with a base member 198 which is connected to the plunger of the solenoid 196 and which is mounted for axial movement within the housing 110. The citrus juicer 100 may then utilize the rotary drive means 40 which is mounted on the base member 198 for axial movement therewith. Accordingly, the motor 42, drive shaft 44 and gearing arrangement 46 will move axially during operation by way of their connection to the base member 198 thus providing for both the axial and rotary movement of the juice extracting element 20.

Alternatively, the axial movement of the juice extracting element 20 may be achieved by way of a linear induction technology.

Additionally, the interlock means may include a first wire portion which has a first end thereof being coupled to the control means 150 and which has a second end thereof being coupled to a portion of the latch means 168 being disposed on the bowl portion 162. A second wire portion has a first end thereof being coupled to the control means 150 and has a second end thereof being coupled to a portion of the latch means 168 being disposed on the cover portion 164. When the cover portion 164 moves into the first position completely covering the juice extracting element 20, the first wire portion operably mates with the second wire portion thus providing a closed loop passage, wherein a control signal sent by one portion of the control means 150 is received by another portion of the control means 150 enabling the control means 150 to enable supply of the operating voltage to the motor 142.

The present invention also contemplates that the working space means 160 of the citrus juicer 100 may be of a unitary construction and updated to be secured to the top end 112 of the hollow housing 110. For example, a quarter turn locking arrangement can be provided within the open end of the working space means 160 and the top end 112 of the hollow housing 110.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. A citrus juicer comprising:
(a) an element for extracting juice from a citrus half;
(b) an elongated hollow housing axially aligned with said juice extracting element and having a top end thereof positioned in close proximity to a base of said juice extracting element;
(c) a rotary drive means which is operably mounted within said housing, said rotary drive means including a motor and a drive shaft operably connected to said juice extracting element;
(d) a power source which is disposed within said hollow housing and which is capable of supplying said predetermined voltage to said rotary drive means, whereby said supply of said predetermined voltage enables said rotary drive means to rotate said juice extracting element; and
(e) a control means for selectively activating and terminating said supply of said predetermined voltage from said power source to said rotary drive means.

2. The citrus juicer, according to claim 1, wherein said citrus juicer includes a stationary guard attached to one end of said housing in said close proximity to said base of said juice extracting element.

3. The citrus juicer, according to claim 2, wherein said guard is formed as a concave annular member capable of containing at least a portion of the juice extracted from the citrus half.

4. The citrus juicer, according to claim 1, wherein said power source includes at least one battery.

5. The citrus juicer, according to claim 4, wherein said at least one battery is one of a group of a rechargeable and a disposable battery.

6. The citrus juicer, according to claim 5, wherein said at least one battery is said rechargeable battery and said citrus juicer further includes means for recharging said rechargeable battery.

7. The citrus juicer, according to claim 1, wherein said control means includes a switch means electrically connected intermediate said rotary drive means and said power source for supplying and terminating said predetermined voltage.

8. The citrus juicer, according to claim 7, wherein said switch means is positioned within a side wall of said hollow housing and is manually operable by the user.

9. The citrus juicer, according to claim 1, wherein said citrus juicer further includes a non-slip grip means disposed on and secured to an exterior surface of said hollow housing.

10. The citrus juicer, according to claim 1, wherein an exterior surface of said housing has a predetermined shape enabling said housing to be ergonomically received within and held by the hand of the user of said citrus juicer.

11. The citrus juicer, according to claim 1, wherein said juice extracting element includes an egg-shaped outer surface, a plurality of spaced vertical grooves and a plurality of spaced annular ridges.

12. The citrus juicer, according to claim 1, wherein said citrus juicer further includes a linear drive means for axially and linearly moving at least said juice extracting element.

13. The citrus juicer, according to claim 1, wherein said citrus juicer further includes means for forming an enclosed and hollow working space for said juice extracting element.

14. The citrus juicer, according to claim 13, wherein said working space means includes a bowl portion which is secured to and extends outwardly and axially from said top end of said housing for at least partially covering said juice extracting element and a cover portion which is engageable with a mouth of said bowl portion for completely covering said juice extracting element.

15. The citrus juicer, according to claim 14, wherein said citrus juicer further includes a hinge means for hingeably attaching said cover portion to said bowl portion enabling said cover portion to be pivotally moved between a first position for covering said juice extracting element and a second position for uncovering said juice extracting element.

16. The citrus juicer, according to claim 14, wherein said citrus juicer further includes a securing means for securing said cover portion being disposed in said first position to said bowl portion.

17. The citrus juicer, according to claim 13, wherein said citrus juicer further includes a plurality of spikes formed within said hollow working means for releaseably securing the citrus half.

18. The citrus juicer, according to claim 13, wherein said citrus juicer further includes a spout disposed on and secured to a predetermined portion of said hollow working space means for communicating flow of the extracted juice external to said citrus juicer.

19. The citrus juicer, according to claim 18, wherein said citrus juicer further includes a filter means operatively secured to said spout for filtering flow of the extracted juice.

20. A citrus juicer comprising:
(a) an element for extracting juice from a citrus half;
(b) an elongated hollow housing axially aligned with said juice extracting element and having a top end thereof positioned in close proximity to a base of said juice extracting element;
(c) a drive means which is operably mounted within the hollow housing for rotating said juice extracting element and for axially and linearly extending and retracting said juice extracting element relative to said top end of said hollow housing;
(d) a power source which is disposed within said hollow housing and which is capable of supplying said predetermined voltage to said drive means, whereby said supply of said predetermined voltage enables said drive means to axially and linearly move said juice extracting element to selectively penetrate and release the citrus half and rotate said juice extracting element for extracting the juice;
(e) a control means for selectively activating and terminating said supply of said predetermined voltage from said power source to said drive means;
(f) means for forming an enclosed and hollow working space for said juice extracting element, said working space means includes a bowl portion which is secured to and extends outwardly and axially from said top end of said housing for at least partially covering said juice extracting element and a cover portion which is engageable with a mouth of said bowl portion for completely covering said juice extracting element, a hinge means for hingeably attaching said cover portion to said bowl portion enabling said cover portion to be pivotally moved between a first position for covering said juice extracting element and a second position for uncovering said juice extracting element;
(g) means for securing said cover portion being disposed in said first position to said bowl portion; and
(h) a spout disposed on and secured to one of said bowl portion and said cover portion for communicating flow of the extracted juice external to said citrus juicer when said cover portion is disposed in said first position.
